(19) United States
(12) Patent Application Publication
(10) Pub. No.: US 2007/0176926 A1
(43) Pub. Date: Aug. 2, 2007

(54) Lighting states in a computer aided design

(76) Inventors: Jose Madeira De Freitas Garcia, San Francisco, CA (US); Joanna Cook Camacho, Oakland, CA (US)

Correspondence Address: FISH & RICHARDSON P.C., PO BOX 1022, MINNEAPOLIS, MN, 55440-1022, US

(21) Appl. No.: 11/344,792

(22) Filed: Jan. 31, 2006

(51) Int. Cl. G06T 15/50

(52) U.S. Cl. 345/426

(57) ABSTRACT

A multi-dimensional model can be displayed according to a lighting state. A multi-dimensional model includes one or more lights. A lighting state includes a set of settings for the one or more lights. The lighting state can be applied to the multi-dimensional model in order to view the multi-dimensional model under the one or more lights, such that the settings of the lights are determined by the applied lighting state. Information about the lighting state is maintained separately from information about the multi-dimensional model.

### TECHNICAL FIELD

This invention relates to computer aided design.

### BACKGROUND

Appropriate lighting is crucial for realistic three dimensional visualization of designs created using computer aided design (CAD) software. Many CAD systems allow a user to add “lights” (i.e., lighting effects) to a computer aided design model to simulate indoor lighting or outdoor lighting, including sunlight. The user may set various settings associated with the lights. The settings associated with the lights are included in the design information database for the design; that is, the design information is altered when lights are applied to a design model or light settings are modified.

Including sunlight in a three dimensional design model may allow a user to visualize shadows that may be cast by buildings in the design, for example, to determine compliance with city regulations, sometimes referred to as a sun study. Sun studies can be conducted to determine shadows at various times of the day and at various times of year. Settings associated with the light representing the sun may be changed to represent various temporal considerations. In conventional CAD systems, a separate copy of the design corresponding to different lighting conditions must be generated for each lighting condition in the sun study. Any change to the design itself can then require all copies of the design information for the various lighting conditions to include the corresponding changes. This can be a tedious, inefficient and error-prone undertaking.

### SUMMARY

This invention relates to the field of computer aided design (CAD). More specifically, the present invention relates to lighting states for three dimensional design models within a CAD environment.

In a general aspect, a multi-dimensional model is displayed according to a lighting state. A multi-dimensional model is received. The model includes one or more lights. A lighting state is received. A lighting state includes a set of settings for the one or more lights. The lighting state is applied to the multi-dimensional model. Information about the lighting state is maintained separately from information about the multi-dimensional model. The multi-dimensional model is displayed according to the applied lighting state.

Implementations may include one or more of the following features. For example, a lighting state may include settings related to attenuation, diffuse reflection, falloff cone angle, hotspot cone angle, intensity, inverse linear attenuation, inverse square, rapid decay areas, shadow or specular reflection. A lighting state may be applied to a multi-dimensional model, where the model may include a distant light and the distant light may include settings related to altitude and azimuth.

The one or more lights included in the multi-dimensional model may include a spot light, a point light, or a distant light. The distant light may represent the sun.

The lighting state may be a first lighting state that may be displayed in a first viewport. A second lighting state may be received. The second lighting state may be applied to the multi-dimensional design. Information about the second lighting state may be maintained separately from information about the multi-dimensional model. The multi-dimensional model may be displayed according to the applied second lighting state, in a second viewport, where the second viewport includes the applied second lighting state. Displaying the multi-dimensional model in a second viewport may include displaying the multi-dimensional model in the second viewport concurrently with displaying the multi-dimensional model in the first viewport.

Receiving a multi-dimensional model may include receiving user input to generate a three dimensional model or receiving user input to import an existing three dimensional model. Receiving a lighting state may include receiving a user input to select a lighting state from among a set of pre-determined lighting states or receiving a user input to select the set of settings comprising the lighting state. Applying the lighting state to the multi-dimensional model may include using interactive three dimensional rendering to apply the lighting state to a three dimensional model.

In another general aspect, a lighting state is generated. A multi-dimensional model is received. The model includes a light representing the sun. A geographic location and temporal information is received. A lighting state is generated based on the geographic location and temporal information. A lighting state includes a set of settings for the light included in the model.

Implementations may include one or more of the features noted above or one or more of the following features. For example, the geographic location may include a latitude and a longitude, a city, a state, a zip code or a street address. Receiving temporal information may include receiving more than one multiple temporal informations. The temporal information may include at least one of a time of day, a date or a season.

Generating a lighting state based on the geographic location and temporal information may include generating multiple lighting states, where each lighting state is based on the geographic location and one of the more than one multiple temporal informations. Generating multiple lighting states may include generating one viewport for each of the multiple lighting states. A viewport may include a window for displaying the multi-dimensional model according to a lighting state.

The lighting state may be applied to the multi-dimensional model. Information about the lighting state may be maintained separately from information about the multi-dimensional model. The multi-dimensional model may be displayed according to the lighting state.

Implementations of the invention can realize one or more of the following advantages. By storing settings for lights (ie., lighting states) included in a CAD model separate from the design information for the model itself, multiple lighting states can be applied to a single copy of the design information, for different presentations of the model according to different light settings. Because the light settings are not part of the design information, multiple copies of the model do not have to be generated to present the design with multiple light settings. If a modification to the model is desired, the single copy of the design information can be modified, and the multiple lighting states reapplied. By contrast, if the light settings were included as part of the design information, and multiple versions of the design information were required to be generated for each set of light settings, then a modification to the model would require modification to each of the multiple versions of the design information, a potentially tedious and time consuming task.

Additionally, a single set of lights can be added to a model, yet different settings (i.e., lighting states) for each of the lights in the set can be applied quickly and easily. For example, if there are three lights in a set of lights, the lights, individually or in a group, can be set to emanate a red color or a green color, be turned on, be turned off, alternate between on and off or green and red, etc. Additionally, or alternatively, the brightness and other attributes for each light individually, or all lights as a set, can easily be applied and modified. In this way, because it is simple to change the attributes of the lights in the set, a true comparative analysis can be undertaken.

Furthermore, settings for a set of lights (i.e., lighting state) can be applied to a model in a viewport, which is a viewing area set up for the model. A model may be viewed in several viewports simultaneously. Although the model information is the same in the several viewports, different lighting information may be applied to the model information on a per-viewport basis. For example, a single model may have two different lighting states applied to it in two viewports. In this way, it is easy to compare lighting styles and attributes in order to optimize and select the best lighting pattern for a given model. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of a system for displaying a model according to one or more lighting states.

FIG. 2 illustrates an exemplary process for displaying a three dimensional model with a lighting state.

FIG. 3 is an illustration of a three dimensional model.

FIG. 4 is an exemplary user interface (UI) for directly adding values to settings for a point light.

FIG. 5 is an exemplary user interface (UI) for directly adding values to settings for a spotlight.

FIG. 6 is an exemplary user interface (UI) for directly adding values to settings for a distant light.

FIG. 7 illustrates an exemplary process for generating a lighting state.

FIG. 8 illustrates a set of exemplary user interfaces (UIs) for entering temporal information for a sun study.

FIG. 9 illustrates lighting states within four viewports generated for a sun study.

Like reference symbols in the various drawings indicate like elements.

### DETAILED DESCRIPTION

Techniques, systems and apparatus for displaying a computer-aided design (CAD) model according to a lighting state is described. A model can include one or more lights representing indoor and/or outdoor lighting. A “lighting state” is a set of settings for the one or more lights included in the model. The lighting state can be applied to the model and the model displayed according to the lighting state. Information about the lighting state is maintained separately from the design information database associated with the model.

Accordingly, a change to the lighting state, or a different lighting state, can be applied to the model without altering the design information. Similarly, if multiple lighting states are created, for example, to conduct a sun study, the multiple lighting states can be applied to the model. If a design change is deemed necessary, for example, based on the results of the sun study, the model itself can be easily modified and the multiple lighting states applied to the modified model. Thus, advantageously, by maintaining a lighting state separate from the design information database for the model, a lighting state can be applied like a filter through which a user can view the model, which will be displayed differently, depending on the selected filter, i.e., lighting state.

A CAD model can include one or more lights, including, for example, sunlight, ambient light and user lights. Sunlight is a representation of the natural sun and can be used, by way of example, to conduct sun studies, which are discussed in more detail below. Ambient light represents an environmental light that exists in the real world. The environmental light, or ambient light, may not be created by an actual light source, but rather can be generated from reflections of a light source on other surfaces. For example, if a box is held under a light bulb, the side of the box directly beneath the bulb (i.e., the top) is lit by the light bulb. However, the other sides of the box (e.g., the bottom) are still visible even though the sides are not in the direct path of the light bulb. The bottom of the box is still visible, despite not being under any direct lighting, because of ambient light that is created, for example, by the reflection of the light bulb on the walls surrounding the light bulb and the box.

User lights include various types of lights a user may add to a CAD model, including, for example, distant lights, point lights, and spot lights. In some implementations, other types of lights can be used, and those described are merely exemplary. Other examples of types of lights include photometric lights and area lights. Distant lights represent lights that emanate light in parallel rays, for example, the sun. Spotlights represent lights that emanate light in a conical shape, for example, the headlights of a car or the light emanating from beneath a lamp shade. Point lights represent lights that emanate light equally in all directions, for example, a single light bulb.

Each light included in the model has one or more settings. For example, a spotlight light can include settings for position, target, fall-off cone, status, shadows, hotspot angle, falloff angle, intensity factor, color, plot glyph, geometry (including position and target), and/or attenuation. A point light can include settings for position, range of influence, status, shadows, intensity factor, color, plot glyph, geometry, and/or attenuation. A distant light can include settings for direction (i e., the direction the light will shine on the model), status (i.e., on/off), shadows, intensity factor, color, and geometry. Ambient light can include settings, for example, a status setting (i.e., whether the ambient light is turned on or off in the design). Sunlight can include settings for time of day, day of year, latitude, longitude, north vector, and/or other settings that may be associated with the sun including seasons, and other geographic location information, such as a street address.

A lighting state is a set of values for the settings of each light included in the model. In one example, a lighting state can include the values of the settings of a particular light in the model. In some implementations, each setting has default values which can be retained for the particular light. More than one lighting state can be applied to a model.

In one implementation, a CAD system can include multiple pre-determined lighting states that a user may select from and apply to a model. In another implementation, a CAD system can include both pre-determined lighting states and user-created (or user-imported) lighting states. In this case, a user may import a lighting state from an outside source, create a lighting state, or adjust a pre-determined lighting state to create a new, different lighting state. Customized lighting states can be named and stored for easy recall by the user and re-use in multiple models.

A user may adjust the settings for a particular light directly by changing the values of various settings associated with the light. A user also may adjust the settings of a particular light indirectly by selecting a lighting state to apply to the design. For example, a design may include a spotlight. When adding the spotlight to the design, a user may set the position setting to value A. Alternatively, or additionally, a user may select a particular lighting state to apply to the model having the spotlight, where the lighting state includes a setting for the spotlight position of value B. Once the lighting state has been applied to the design, the position setting for the spotlight may change from value A to value B.

The values applied to the light settings for the group of lights within the model (i.e., the lighting state) are stored separately from the design information database for the model. It is important that the lighting state be stored separately to allow a user to apply various lighting states to the model without having to edit the design information database each time a light setting is added or changed, and to avoid having to generate multiple copies of the design information database for each of a number of different lighting states.

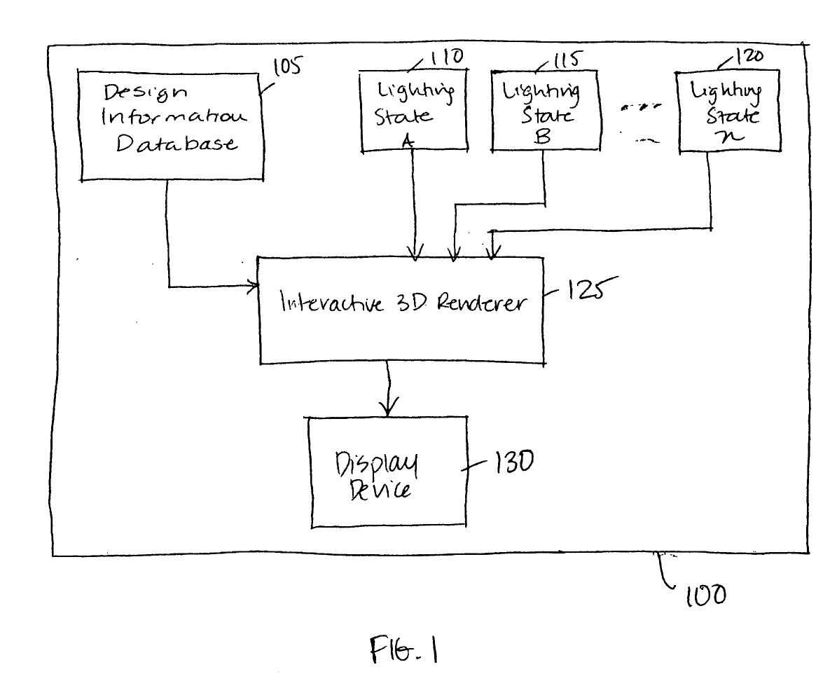

FIG. 1 is a schematic representation of a system 100 for generating a display of a model with a lighting state applied. The system 100 is simplified for illustrative purposes, and in practice, a system can be configured differently and can include more or fewer components than shown.

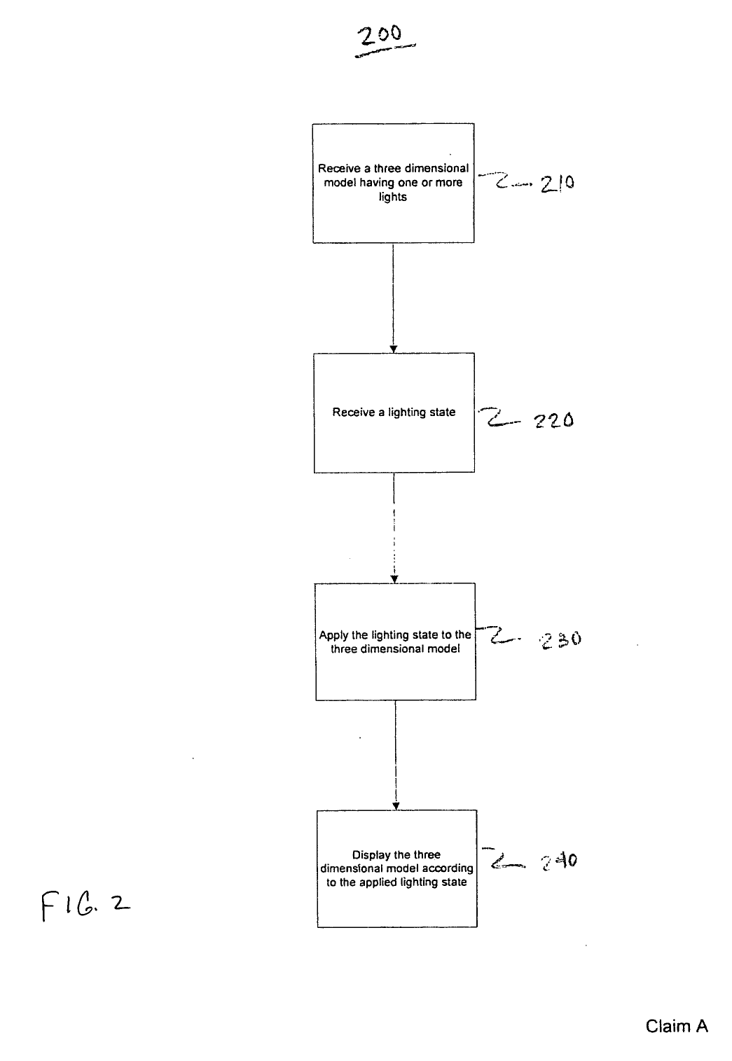

System 100 includes design information database 105, lighting states 110, 115 and 120, interactive three dimensional (“3D”), renderer 125 and display device 130. The components of system 100 will be described in more detail below with the discussion of process 200 of FIG. 2.

FIG. 2 illustrates an exemplary process 200 for displaying a three dimensional model according to a lighting state. The process 200 may be executed by a CAD system, for example, AutoCad available from Autodesk, Inc., in San Rafael, Calif., or another CAD application or other software application with CAD functionality. In one implementation, the CAD system includes some or all of the system components shown in the system 100 in FIG. 1.

The process 200 begins when the CAD system receives a three dimensional model having one or more lights (Step 210). Alternatively, the received three dimensional model may not yet include lights. In this case, a user may apply lights to the three dimensional model on an individual basis (e.g., applying one light at a time) or as a group (e.g., applying a user-created or pre-determined set of lights to a model at once). Receipt of the three dimensional model having one or more lights may occur when a user creates a three dimensional model, edits an existing three dimensional model, or imports a three dimensional model from another source. Referring to FIG. 1, the design information database 105 can include a three dimensional model which can be retrieved in step 210 to start the process 200.

The process 200 continues when the CAD system receives an identification of a particular lighting state to be applied to the model (Step 220). The lighting state could be identified in real time by an end user (e.g., selecting a particular light state from a list), or be otherwise associated with the light As described previously, a lighting state is a set of settings for the one or more lights included in the three dimensional model. A user may select a lighting state from a list of pre-determined lighting states, import a lighting state from another source, edit an existing lighting state (either pre-determined, imported, or user-created) to create a new lighting state. Referring again to FIG. 1, the received lighting state can be one of the multiple lighting states 110, 115 or 120, as shown.

The CAD system then applies the lighting state to the three dimensional model (Step 230). In one implementation, interactive three dimensional (“3D”) rendering is used to apply the lighting state to the three dimensional design. A rendering engine leverages a combination of software algorithms and graphics hardware capabilities to display a three dimensional design with the one or more lights set according to the values included in the lighting state being applied. In one implementation, a type of rendering engine called a shader can be used to apply a lighting state to a three dimensional design. A shader is a software tool that can be loaded into graphics hardware and executed natively. Referring again to FIG. 1, the rendering engine can be the interactive 3D renderer 125 shown in the system 100.

The CAD system then displays the three dimensional design according to the applied lighting state (Step 240). The rendering engine displays the three dimensional design such that the one or more lights in the model have settings set to the values provided by the lighting state. For example, the sun may be set to a particular time of day, certain user lights may be on or off, a spotlight may have a certain intensity, etc. Referring again to FIG. 1, the design can be displayed on a display device 130 included in the system 100.

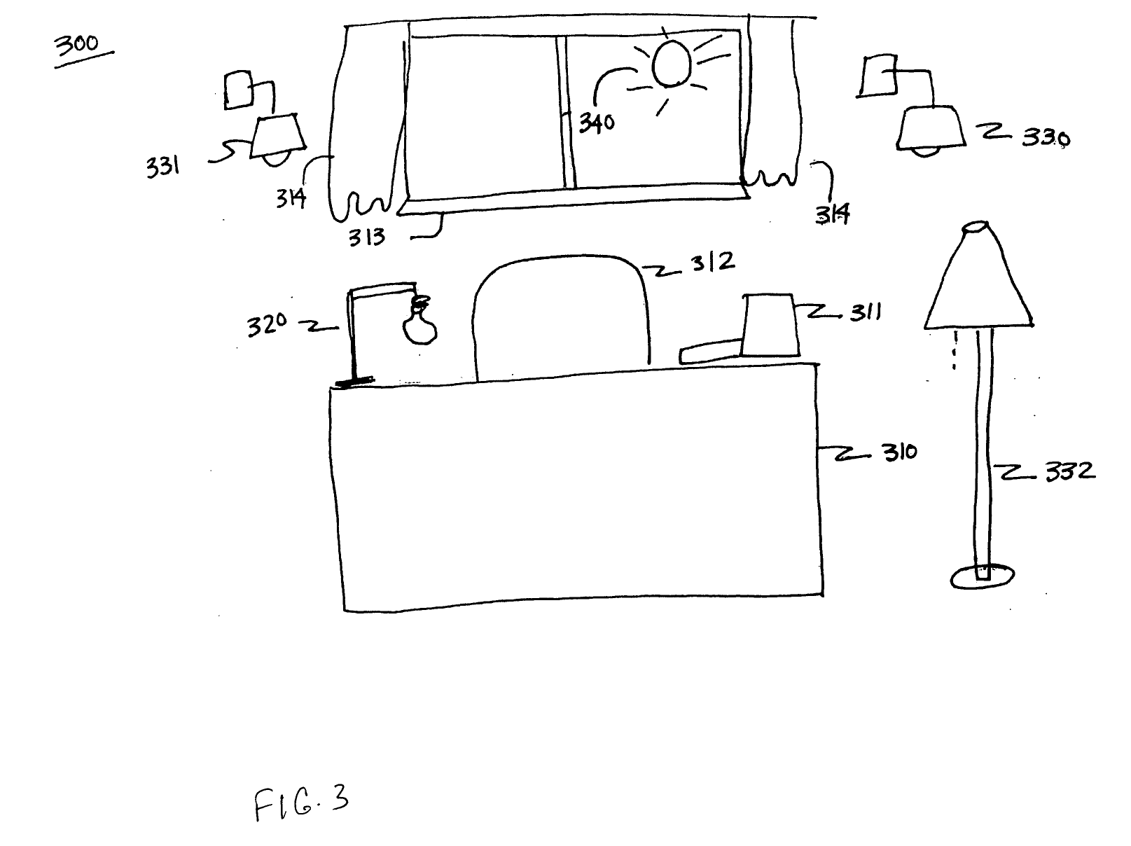

FIG. 3 is a schematic representation of a three dimensional model 300. The model 300 represents a home office, and includes a desk 310, a computer 311, a chair 312, and a window 313, having curtains 314. More importantly, the model 300 includes a group of lights, including wall sconces 330 and 331, a floor lamp 332, a desk light 320 and the sun 340 shining through the window 313.

The wall sconces 330 and 331 and the floor lamp 332, may be represented in the three dimensional design as spotlights, since each lamp has a shade that will cause light to emanate beneath the shade in a conical shape. The sun 340 may be represented as a distant light because it emanates light, through the window and into the room, in parallel rays. The desk lamp 320 may be represented as a point light since a single light bulb may emanate light equally in all directions.

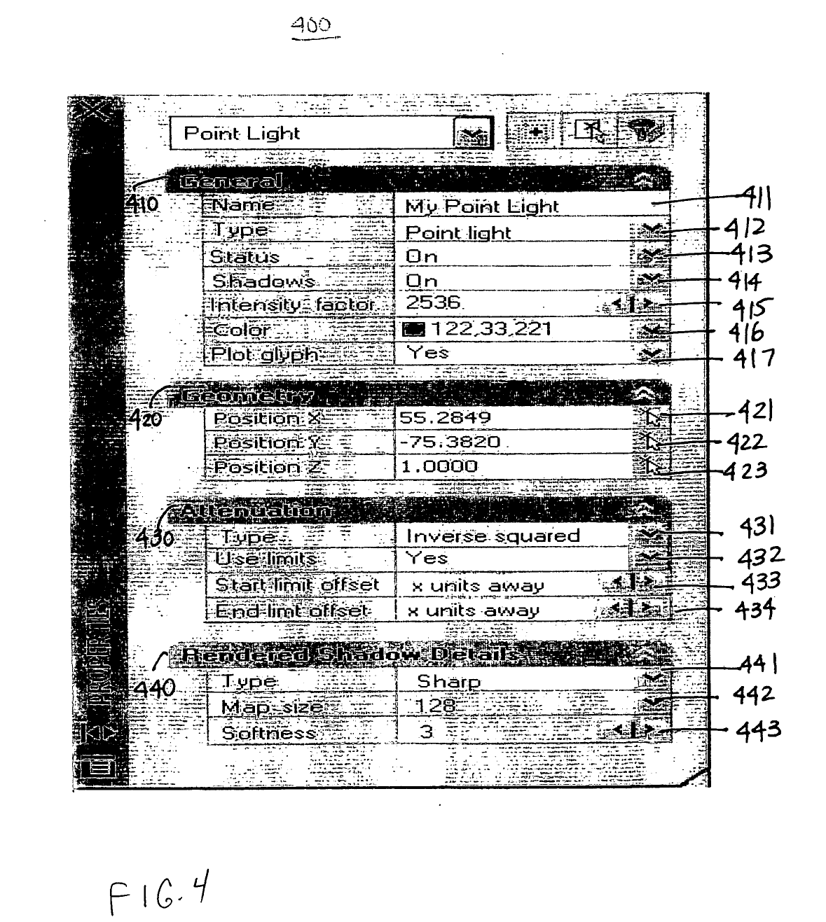

Once a user has created the non-light elements of model 300, the user may add the lights. Each light may be added using a best representation of the real-world light fixture. As described above, the wall sconces 330 and 331 and floor lamp 332 can be represented by spotlights, the sun 340 can be represented as a distant light, and the desk lamp 320 can be represented by a point light. Each of the lights to the three dimensional model can be added by way of a user interface (UI). Thereafter, a user may edit one or more settings associated with each light, or leave one or more settings at a default value. Exemplary user interfaces include those shown in FIGS. 4, 5 and 6. Alternatively, a user may select, or create, a lighting state to apply to model 300, also by using a UI. Applying the lighting state to model 300 automatically sets the settings for each of the lights at the values specified by the lighting state. By way of example, a user may select one lighting state to represent a day-time lighting scheme (e.g., the artificial lights may be off or shining at a low level due to the natural sunlight streaming in through window 313) and another lighting state to represent an evening lighting scheme (e.g., higher levels of artificial lights to compensate for the lack of sunlight).

FIG. 4 is an exemplary user interface (UI) 400 for receiving user input to set the values of the settings for a point light. As described above, a point light is a light that emanates light in all directions. The intensity of a point light diminishes over distance. Point lights are useful for representing general lighting effects.

In the implementation shown, multiple settings exists for a point light, although in other implementations more or fewer settings may be included for each point light. Under the general category 410, a point light has settings labeled name 411, type 412, status 413, shadows 414, intensity factor 415, color 416, and plot glyph 417.

Name 411 allows a user to give a particular point light a distinct name. This may help the user distinguish one point light from another. Type 412 indicates that this light is a point light. Changing the type will cause the light to change types and may result in the presentation of a different UI to the user. The status 413 setting determines whether the light object is emitting light (i.e., is the light on or off). The shadows 414 setting determines whether the light object casts shadows (i.e., are shadows turned on or off). Intensity factor 415 indicates the brightness of the light. Color 416 allows a user to select a color for the light. A point light having a light color other than white may emit light in that color, for example green, and may cause the three dimensional model to take on a green hue. Plot glyph 417 relates to whether or not to plot the light glyph. A glyph is a shape. Plotting a light glyph refers to plotting the shape of the light emitted from the point light.

Under the geometry category 420, a point light has settings labeled position X 421, position Y 422, and position Z 423. The positions X, Y, and Z 421-423 refer to where the light is located within the three dimensional model. Changing the values in the geometry category may move the position of the light within the model.

In the attenuation category 430, a point light has settings labeled type 431, use limits 432, start limit offset 433, and end limit offset 434. Type 431 controls how light intensity diminishes over distance. The farther away an object is from a point light, the darker the object appears. Three possible types exist: none, inverse linear and inverse square. Entering “none” as a value for type 431 may cause no attenuation to be set. Selecting “inverse linear” as the value for type 431 may set light decay as the inverse of the linear distance from the point light. Selecting “inverse square” as the value for type 431 may set light decay as the inverse of the square of the distance from the point light. Use limits 432 sets whether limits will be used in defining the attenuation. If use limits 432 is set to yes, then start limit offset 433 and end limit offset 434 may be set, respectively, to indicate the start point of where light is emitted and the end point beyond which no light is cast.

Under the rendered shadow details category 440, a point light has settings labeled type 441, map size 442, and softness 443. Rendered shadow details settings are only available if shadows 414 is set to on. Otherwise, the entire rendered shadow details category 440 is hidden, obfuscated, or otherwise deactivated (e.g., grayed out). Type 441 indicates the type of shadow cast by the point light. Map size 442 indicates the size of the shadow map. Softness 443 defines the softness or fuzziness of shadow-mapped shadows.

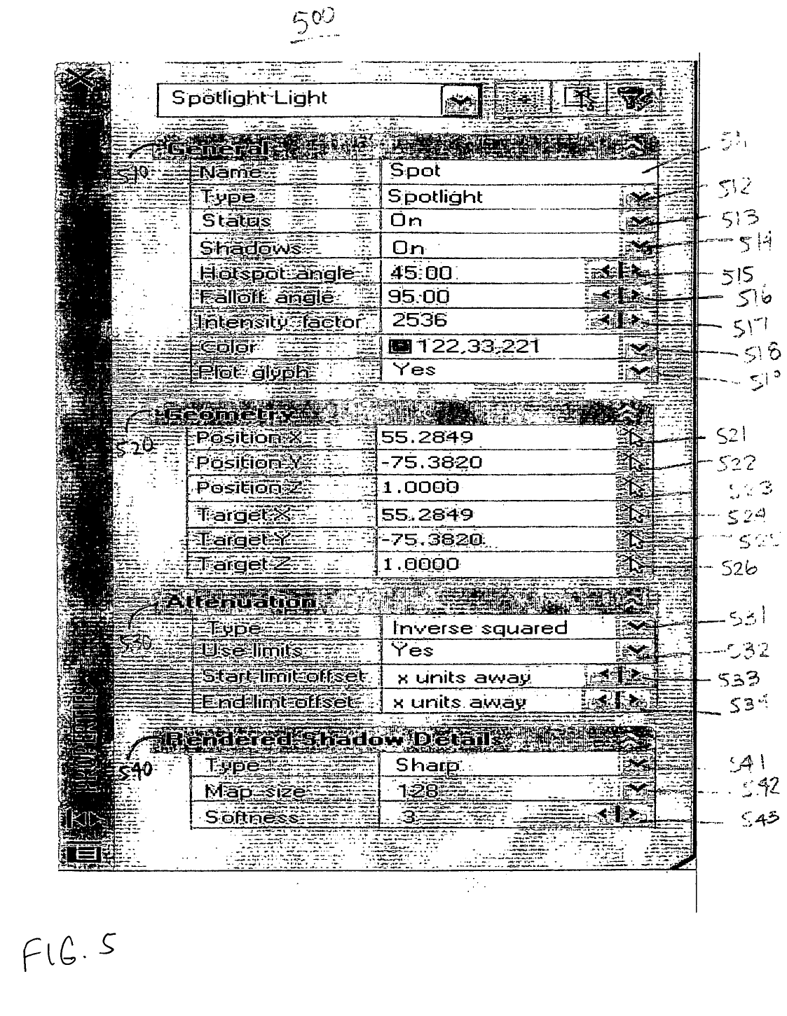

FIG. 5 is an exemplary user interface (UI) 500 for receiving user input setting the values of the settings for a spotlight. A spotlight is a light object that emanates light in the shape of a directional cone. Like point lights, the intensity of a spotlight diminishes over distance. A spotlight is useful to represent light emitted from beneath a lamp shade.

As is shown, in one implementation, multiple settings exist for a spotlight and many of the settings are identical to the settings for a point light. In other implementations, more or fewer settings can be included for a spotlight. In the implementation shown, the spotlight settings that are identical to the settings for a point light included under the general category 510 and are name 511, type 512, status 513, shadows 514, intensity factor 517, color 518, and plot glyph 519. Under the geometry category 520, the identical settings include position X 521, position Y 522, and position Z 523. Under the attenuation category 530, type 531, use limits 532, start limit offset 533, end limit offset 534, as well as the settings under the rendered shadow details 540 including type 541, map size 542, and softness 543 are also the same as for a point light.

Additionally, the UI 500 includes some settings for a spotlight that are different then those for a point light. Under the general category 510, a spotlight has additional settings labeled hotspot angle 515 and falloff angle 516. Hotspot angle 515 specifies the angle that defines the brightest cone of light. Falloff angle 516 specifies the angle that defines the full cone of light, also known as the field angle. For example, a spotlight may have a particular cone associated with the light emanating from the spotlight. The falloff angle defines the full cone of light, while the hotspot angle defines the brightest cone within the full cone, which is typically located in the center of the full cone.

Under the geometry category 520, a spotlight has additional settings labeled target X 524, target Y 525, and target Z 526. The Targets X, Y, and Z 524-526 refer to where the light emanating from the cone of the light object is directed in the three dimensional model. For example, if a spotlight is directed to shine on a desk, the location where the light hits the desk is defined by the Target X, Y, and Z coordinates.

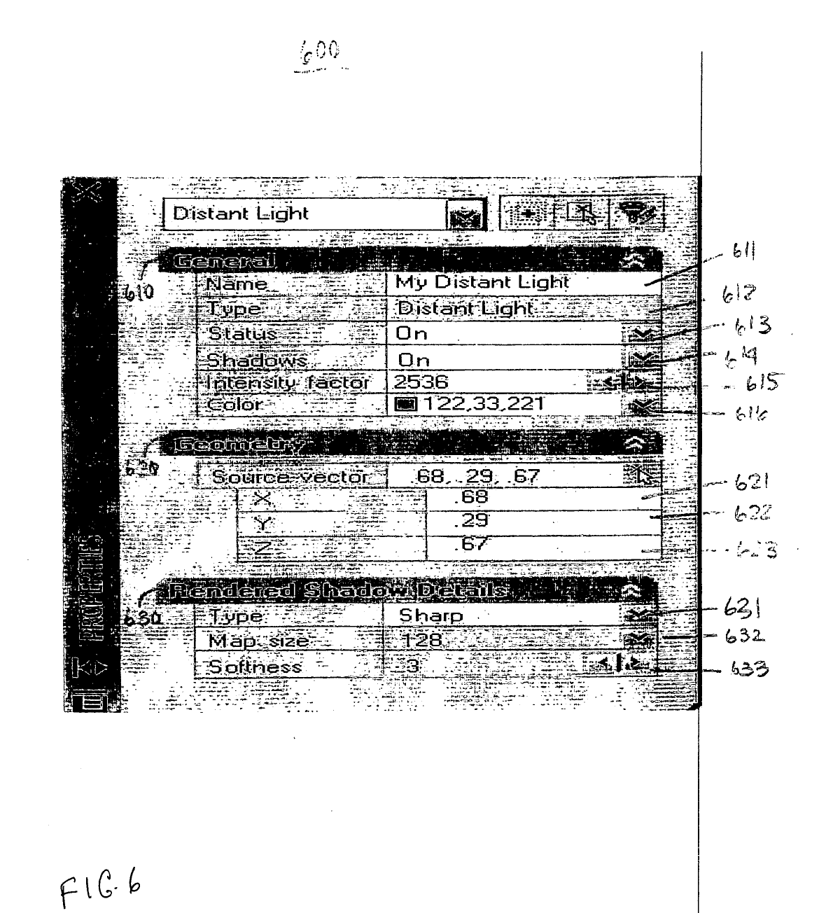

FIG. 6 shows an exemplary user interface (UI) 600 for receiving user input setting values for the settings for a distant light. A distant light is a light that emanates light in uniform parallel light rays in one direction. The light rays may extend infinitely on either side of the point specified as the source of the distant light. A distant light is useful to represent the natural sun.

In some implementations, a representation of the natural sun and a representation of a distant light may be presented to a user as different light types (possibly having different settings) and also may be rendered by the system in a different way. In this configuration, a sun light may be used to represent the natural sun and a distant light may be used to represent a light that emanates light in uniform parallel light rays in one direction.

As is shown, in one implementation, multiple settings exist for a distant light and many of the settings are identical to the settings for a point light or a spotlight. More particularly, a distant light has many of the same settings as a point light or a spotlight, including, under the general category 610, name 611, type 612, status 613, shadows 614, intensity factor 615, and color 616. Under the rendered shadows details category 630, type 631, map size 632, and softness 633 are also identical to those settings for a point light or a spotlight.

UI 600 also includes some settings for a spotlight that are different from a point light or spotlight. More particularly, under the geometry category 620, a distant light includes settings labeled source vector X 621, Y 622, and Z 623. The source vector specifies the light source vector that results from the position of the distant light within the three dimensional model. The position may be set using azimuth and altitude. Azimuth is the direction of a celestial object (e.g., the sun) measured clockwise around the observer's horizon from north. The altitude specifies the position of the distant light by using site-based coordinates.

Although specific settings have been discussed for each of the user lights, with respect to UIs 400, 500, and 600 of FIGS. 4, 5, and 6, respectively, other settings may exist for a particular light, either inherently in the CAD system or due to an addition by a user, such as creation or importation of a new light type or additional settings for an existing light type.

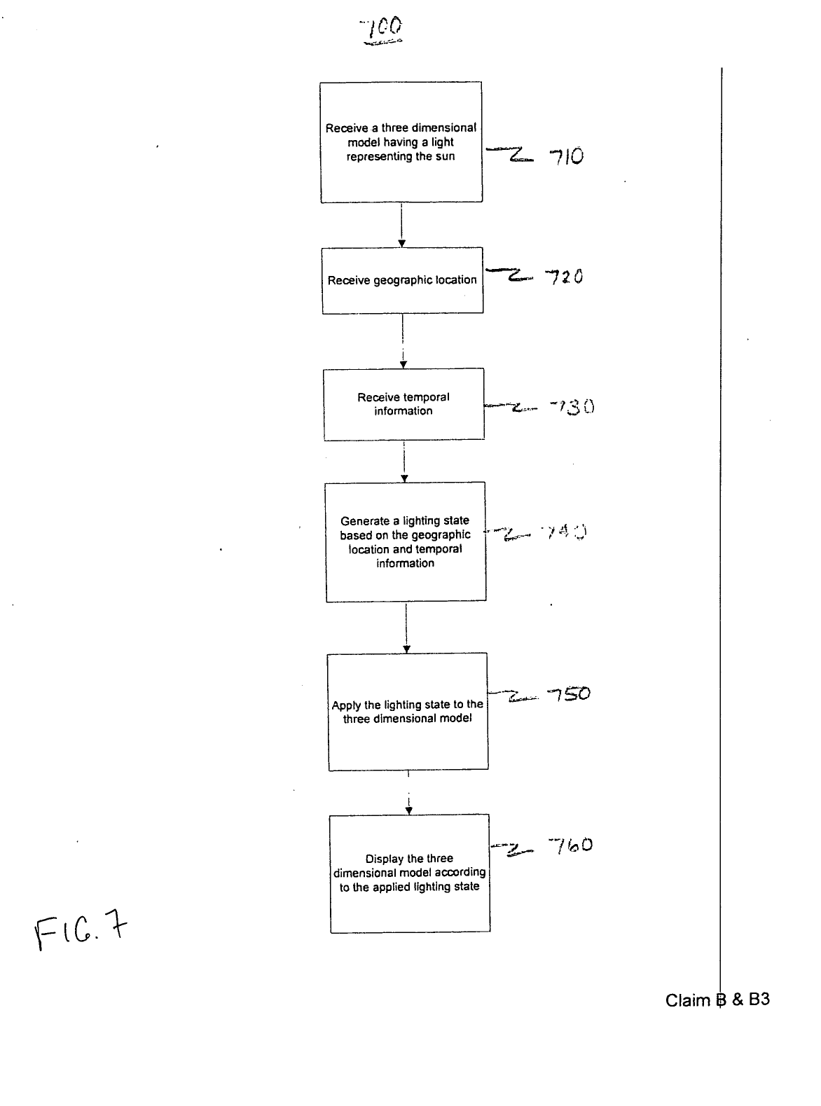

FIG. 7 illustrates an exemplary process 700 for generating a lighting state. In one implementation, the process 700 can be executed by a CAD system. The process 700 generally relates to automatically generating lighting states for a sun study in relation to geographic location and temporal information provided by a user.

A sun study can be used to predict the effect of sunlight and shadows on a given space as a result of a structure (e.g., a building) at different times (e.g., different times of the day and/or times of the year). Buildings generally must comply with certain city and county regulations governing the amount of time the building may cast a shadow on the surrounding area. For example, a skyscraper that completely blocks sunlight from a neighboring park for more than 2 hours in any given day may not be permissible under certain local regulations. In order to establish that a planned building is in compliance with certain regulations, architects may conduct a sun study using a CAD system executing process 700 and the functionality described below with respect to FIGS. 7-9.

The process 700 begins when the CAD system receives a three dimensional model including a light representing a source (e.g., the sun) (Step 710). As described previously with respect to FIG. 2, receipt of the three dimensional model may occur when a user creates a three dimensional model, edits an existing three dimensional model, or imports a three dimensional model from another source.

The process 700 continues when the CAD system receives a geographic location (Step 720). The geographic location may be a latitude and longitude, a location of a north vector, a street address, a city, a state, or a zip code. In one implementation, a user may enter geographic location information using a UI. In another implementation, geographic location information may be automatically gleaned by the CAD system from, for example, a user's profile information, possibly provided when the user bought or registered the CAD system software. In other implementations, geographic location information may be received by the CAD system in another way. The geographic location is important in order for the CAD system to accurately position the light (i.e., sun) within the three dimensional model.

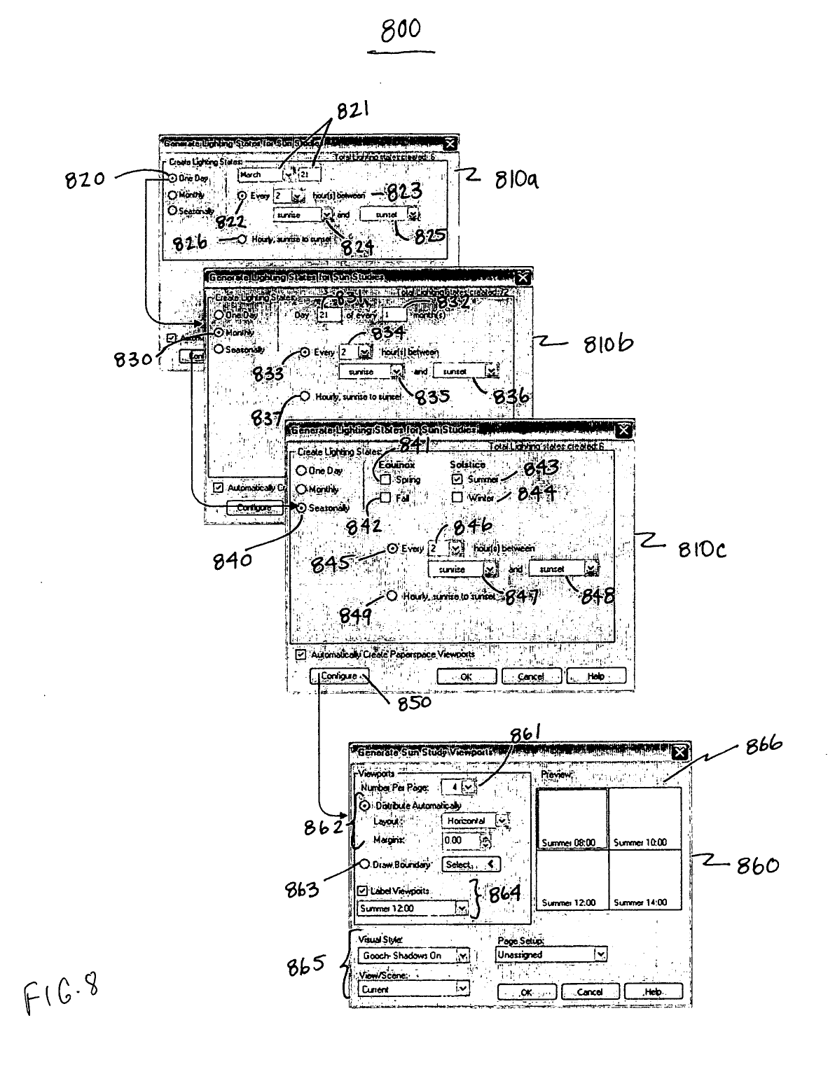

The CAD system then receives temporal information (Step 730). Temporal information may include one or more of a date of the year, a time of day, or a season. The temporal information is also important for the proper functioning of a sun study because the position of the sun in the sky, as well as the intensity of the sun's rays, may differ depending on the day of the year and the hour of the day. In some implementations, a user may enter temporal information using one or more UIs, such as the UIs 800 of FIG. 8, described below. In other implementations, temporal information may be gleaned from another source, such as a project timeline, or city regulations.

A lighting state based on the geographic location and temporal information is generated (Step 740). That is, the geographic location and temporal information can be used to determine the values of the settings for the light representing the source, e.g., the sun. For example, the geographic location and temporal information may provide the position of a distant light within the three dimensional model, and position may affect the source vector settings for the distant light.

The lighting state can thereafter be applied to the three dimensional model (Step 750). In one implementation, the lighting state is applied using interactive three dimensional (“3D”) rendering, as described previously with respect to FIG. 2.

Finally, the three dimensional model can be displayed according to the applied lighting state (Step 760). A renderer can display the three dimensional model such that the light (e.g., the sun) is at the position provided by the generated lighting state.

Although the process 700 is described with respect to generating a single lighting state, typically a sun study requires generation of multiple lighting states to simulate the sun's position at various times either throughout different times of a day, or throughout different days of the year. Therefore, a user may enter more than one value for the temporal information and a lighting state may be generated for each of the values.

For example, to conduct a sun study at a particular geographic location throughout a year, a user may enter temporal information including winter, spring, summer, and fall. In another example, to conduct a sun study for a particular location every few hours on a particular day of the year, a user may enter temporal information including defining states at 8:00 AM, 10:00 AM, 12:00 Noon, and 4:00 PM. In both of these examples, four lighting states may be generated, each representing the position of the sun at the geographic location received in operation 720, during the winter, spring, summer, and fall, or at 8:00 AM, 10:00 AM, 12:00 Noon, and 4:00 PM.

FIG. 8 illustrates a set of exemplary UIs, collectively referred to as UIs 800, for entering temporal information for a sun study. UIs 810a, 810b, and 810c represent the same UI where a user has indicated a different temporal information type for generating lighting states for a sun study.

In UI 810a, a user has selected radio button 820 indicating that the temporal information type is one day. This means that the lighting states generated for this sun study may be over the period of one day at various hours of the day. A user may select the date by using drop down and text entry boxes 821. For example, a user has entered March 21st as the date of the sun study. The user then may determine how often to study the sun (i.e., how many lighting states to generate) by selecting one of radio buttons 822 or 826. Selecting radio button 822 requires a user to enter an interval of hours 823 (e.g., every 2 hours) for which a lighting state may be generated, as well as the bounds of the intervals 824 and 825 (e.g., between sunrise and sunset). Selecting radio button 826 sets the sun study interval to once an hour for the entire day.

In UI 810b, a user has selected radio button 830 indicating that the temporal information type is monthly. In this case, the CAD system may generate a study of the sun (i.e., a lighting state) once a month on the date specified in text entry box 831 (e.g., the 21st day of each month). Alternatively, a user may set the CAD system to generate a lighting state at a different interval by using text entry box 832. For example, instead of generating a lighting state once a month, the user may set the CAD system to generate a lighting state every three months. As with UI 810a, in UI 810b, a user also may determine how often to study the sun (i.e., how many lighting states to generate) by selecting one of radio buttons 833 or 837. Selecting radio button 833 requires a user to enter an interval of hours 834 (e.g., every 2 hours) for which a lighting state may be generated, as well as the bounds of the intervals 835 and 836 (e.g., between sunrise and sunset). Selecting radio button 837 sets the sun study interval to once an hour for the entire day.

In UI 810c, a user has selected radio button 840 indicating that the temporal information type is “seasonally”. In this case, the CAD system may generate a study of the sun (i.e., a lighting state) once every season (e.g., winter, spring, summer, and fall). A user may elect to generate a lighting state for one or more seasons using check boxes 841, 842, 843, and 844. Again, a user may indicate how often during the seasons to study the sun (i.e., how many lighting states to generate) by selecting one of radio buttons 845 or 849. If the user selects radio button 845, the user may further enter an interval of hours 846 (e.g., every 2 hours) for which a lighting state may be generated, as well as the bounds of the intervals 847 and 848 (e.g., between sunrise and sunset).

Once the required information in UI 810a, 810b, or 810c has been entered by the user, selected, or accepted (e.g., accepted a default setting), the user may click configure button 850. Clicking configure button 850 causes UI 860 to be displayed. UI 860 allows a user to generate viewports for the sun study. A drawing area in a CAD environment (where a user may create or edit a three dimensional model) may be split into one or more adjacent rectangular views referred to herein as viewports. Viewports can be used to display different views of a three dimensional model. In large or complex drawings, displaying different views can reduce the time needed to zoom or pan in a single view. Also, errors a user may miss in one view may be apparent in the others. Changing the three dimensional model in one viewport causes other viewports to be updated simultaneously, as there is only one copy of the model even though it is being displayed simultaneously in multiple viewports.

In one implementation, each lighting state generated for the sun study is applied to the three-dimensional model and displayed in a separate viewport. In this case, there may be as many viewports generated as lighting states. A user may use UI 860 to define various features related to the viewports. For example, a user may select a number of viewports to be shown per page 861. The user also may define various attributes of each viewport, such as how the viewports will be distributed on the page 862, whether the viewports will have a visible boundary 863, whether the viewport will be labeled and what the label will be 864, as well as other attributes 865. As each of the viewport attributes are defined and/or adjusted, a viewport preview 866 shows what the defined viewports may look like as they display the three dimensional model according to the lighting states generated for the sun study.

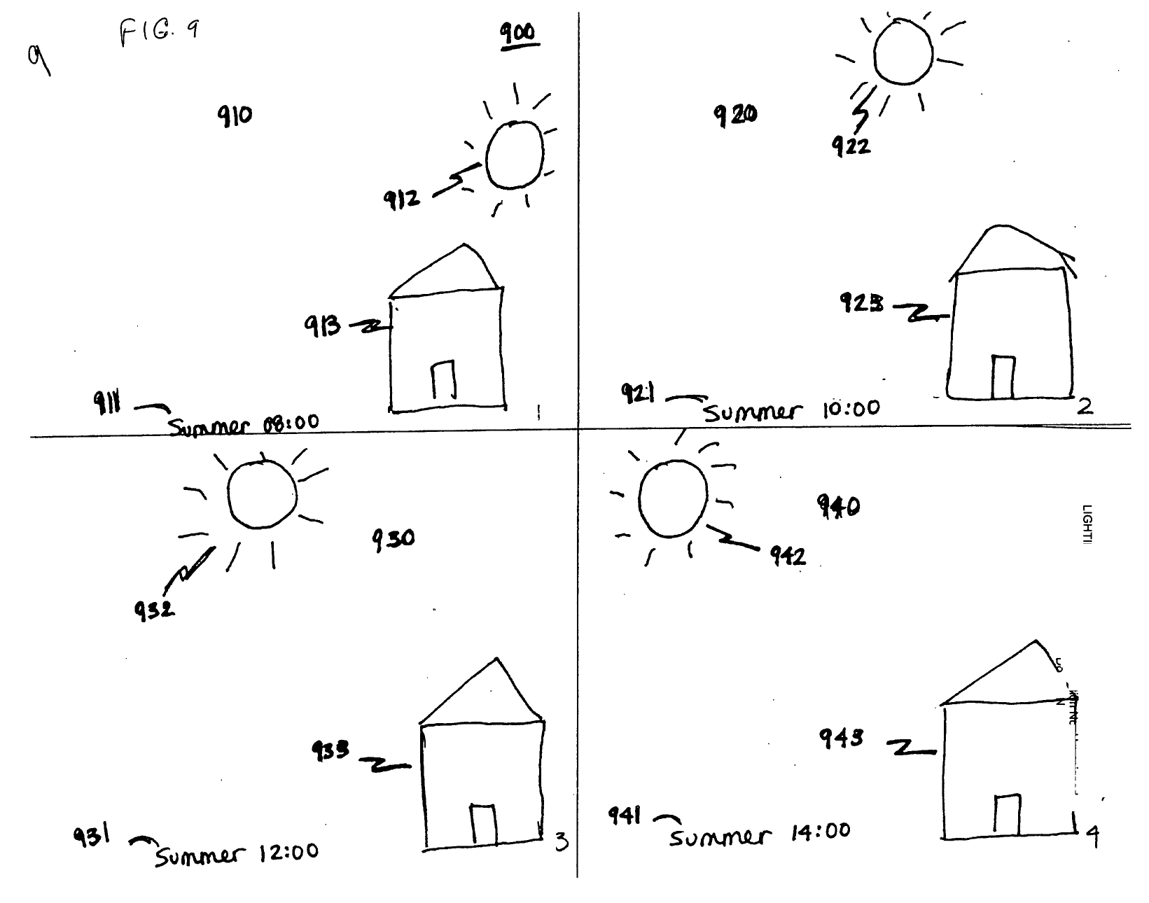

FIG. 9 is a schematic representation illustrating lighting states, within four viewports (collectively viewports 900), generated for a sun study. Upon entering/receiving/defining temporal information in UI 810c and viewport information in UI 860, both of FIG. 8, viewports 900 can be generated by the CAD system to display four different lighting states as applied to a three dimensional model.

Viewport 910 includes label 911 “Summer 08:00.” The label 911 indicates that viewport 910 is displaying a lighting state such that the distant light (i.e., the sun 912), emanates light as would the natural sun on a summer day at 8:00 AM. In viewport 910, a user may view how the summer morning sun 912 shines on house 913 and what shadows, if any, the sun 912 may cast.

Similarly, viewports 920, 930, and 940 each display a lighting state for the sun at various other times (and positions 922, 932 and 942 respectively) during the summer day. More particularly, viewport 920 includes label 921 “Summer 10:00,” viewport 930 includes label 931 “Summer 12:00,” and viewport 940 includes label 941 “Summer 14:00.” Labels 921, 931, and 941, like label 911 of viewport 910, indicate the time of the summer day represented by the lighting state displayed in each of the viewports. Additionally, in each viewport, a user may view how the summer sun, at different times of the day, shines on the structure, i.e., the house.

A sun study can be conducted without using multiple viewports, in which case, the model can be viewed with each of several lighting states applied separately, as compared to the viewport model which allows simultaneous viewing. It should be noted though, that although each viewport presents the model with a different lighting state applied, only one copy of the design information database for the model is required. Each lighting state is applied to the design as a filter, and the model is presented with the different “filters” applied. By contrast, if the light settings are stored with and become part of the design information database, then multiple copies of the design information database must be generated for presentation of each different set of light settings. If the underlying model is then modified, each copy of the design information database has to be modified identically. One advantage of lighting states is that because there is only one design information database of the design, if a modification is required, the model is modified once, and the lighting states can be reapplied to the modified design.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users. A number of embodiments of the invention have been described. Nevertheless, it will be understood that various modifications may be made without departing from the spirit and scope of the invention. Accordingly, other embodiments are within the scope of the following claims.

What is claimed is:

1. A method for displaying a multi-dimensional model according to a lighting state, the method comprising:
receiving a multi-dimensional model, the model including one or more lights;
receiving a lighting state, where a lighting state comprises a set of settings for the one or more lights;
applying the lighting state to the multi-dimensional model, where information about the lighting state is maintained separately from information about the multi-dimensional model; and
displaying the multi-dimensional model according to the applied lighting state.

2. The method of claim 1 where a lighting state includes settings related to at least one or more of attenuation, diffuse reflection, falloff cone angle, hotspot cone angle, intensity, inverse linear attenuation, inverse square, rapid decay areas, shadow or specular reflection.

3. The method of claim 2, where a lighting state applied to a multi-dimensional model including a distant light further includes settings related to a least one or more of altitude and azimuth for the distant light.

4. The method of claim 1, where the one or more lights included in the multi-dimensional model includes at least one of a spot light, a point light, or a distant light.

5. The method of claim 4, where the distant light represents the sun.

6. The method of claim 1, where the lighting state is a first lighting state and the first lighting state is displayed in a first viewport, the method further comprising receiving a second lighting state;
applying the second lighting state to the multi-dimensional design, where information about the second lighting state is maintained separately from information about the multi-dimensional model; and
displaying the multi-dimensional model, according to the applied second lighting state, in a second viewport, where the second viewport includes the applied second lighting state.

7. The method of claim 6, where displaying the multi-dimensional model in a second viewport includes displaying the multi-dimensional model in the second viewport concurrently with displaying the multi-dimensional model in the first viewport.

8. The method of claim 1, where receiving a multi-dimensional model comprises receiving user input to generate a three dimensional model.

9. The method of claim 1, where receiving a multi-dimensional model comprises receiving user input to import an existing three dimensional model.

10. The method of claim 1, where receiving a lighting state comprises receiving a user input to select a lighting state from among a set of pre-determined lighting states.

11. The method of claim 1, where receiving a lighting state comprises receiving a user input to select the set of settings comprising the lighting state.

12. The method of claim 1, where applying the lighting state to the multi-dimensional model comprises using interactive three dimensional rendering to apply the lighting state to a three dimensional model.

13. A method for generating a lighting state, the method comprising:
receiving a multi-dimensional model, the model including a light representing the sun;
receiving a geographic location;
receiving temporal information; and
generating a lighting state based on the geographic location and temporal information, where a lighting state comprises a set of settings for the light included in the model.

14. The method of claim 13, where the geographic location includes at least one of a latitude and a longitude, a city, a state, a zip code or a street address.

15. The method of claim 13, where receiving temporal information includes receiving more than one multiple temporal informations.

16. The method of claim 15, where the temporal information includes at least one of a time of day, a date or a season.

17. The method of claim 15, where generating a lighting state based on the geographic location and temporal information comprises generating multiple lighting states, where each lighting state is based on the geographic location and one of the more than one multiple temporal informations.

18. The method of claim 17, where generating multiple lighting states comprises generating one viewport for each of the multiple lighting states, where a viewport comprises a window for displaying the multi-dimensional model according to a lighting state.

19. The method of claim 13, where the method further comprises:
applying the lighting state to the multi-dimensional model, where information about the lighting state is maintained separately from information about the multi-dimensional model; and
displaying the multi-dimensional model according to the lighting state.
